(19) United States
(12) Patent Application Publication
(10) Pub. No.: US 2020/0269629 A1
(43) Pub. Date: Aug. 27, 2020

(54) PEN STRUCTURE CONTAINING LIQUID INK

(71) Applicant: CAPTIVA PACKAGING CO., LTD., TAINAN CITY (TW)

(72) Inventor: PO-I SHIH, TAINAN CITY (TW)

(21) Appl. No.: 16/284,144

(22) Filed: Feb. 25, 2019

(51) Int. Cl. B43K 5/18; B43K 1/00; B43K 3/00; B43K 5/00

(52) U.S. Cl. CPC B43K 5/1836; B43K 5/005; B43K 3/00; B43K 1/006

(57) ABSTRACT

A pen structure containing liquid ink is disclosed herein. It comprises a tube body having a reservoir and an open end; a liquid outflow bushing disposed at the open end and accommodated in the reservoir of the tube body at one end thereof, wherein the liquid outflow bushing has a liquid delivering space and a screw groove disposed on a wall of the liquid delivering space and connected to an end face of the liquid delivering space at one end thereof; and a brush disposed in the liquid delivering space of the liquid outflow bushing and surrounded by the screw groove at one end thereof.

### BACKGROUND OF THE INVENTION

### 1. Field of the Invention

The present invention relates to a pen structure containing liquid ink which comprises a screw groove having one end connected to the external environment to introduce external air into a pen tube so as to balance the gas and liquid pressure when the liquid is discharged from a nib and an internal pressure of the pen tube is decreased and make the liquid smoothly flow out.

### 2. Description of Related Art

Eyeliner is an eye makeup that is usually applied on the eyelids to define the contours of the eyes to increase aesthetic effects. Generally, the eyeliner liquid is stored in a liquid storage space inside the eyeliner. According to the colors of the eyeliner, the eye liner of different colors can be drawn. When the eyeliner is used, it is necessary to maintain a proper outflow of the eyeliner liquid. If the eyeliner liquid is flowed out excessively, too much eyeliner liquid affects the makeup effect. In contrast, if the eyeliner liquid does not flow out sufficiently, the user cannot apply the eyeliner liquid smoothly.

Cosmetic pens containing liquids, e.g. eyeliners or eye shadow pens, are often susceptible to factors of temperature and pressure which in turn affect the outflows of brushes. When the pigment liquid flows out from a tip of the brush, a negative pressure is formed inside the liquid storage space of a pen tube. As the result, the amount of adsorbed liquid of a cotton refill is decreased and the outflow of the liquid at the tip is insufficient. In order to balance the gas and liquid pressure inside the liquid storage space of the pen tube and keep the liquid flowing out of the brush smoothly, the pen tube holder is usually provided with an air flow path axially passing through the liquid storage space of the pen tube.

For instance, the Taiwan patent TW M440028 (U), issued on 1 Nov. 2012, has disclosed an eye liner having an automatic liquid discharge device; the Taiwan patent TW M549002 (U), issued on 21 Sep. 2017, has disclosed a liquid eyeliner having liquid storage function; the Taiwan patent TW M495772 (U), issued on 21 Feb. 2015, has disclosed a liquid eyeliner with an integral cotton core; and the Taiwan patent TW M463535 (U), issued on 21 Oct. 2013, has disclosed an eye liner having an automatic liquid discharge device.

Although the abovementioned structures improve the smoothness of the outflow of the eyeliner liquid, the abovementioned structures are quite complex and require complicated processes during manufacturing or assembly. Furthermore, after the abovementioned structures are used for a period of time, the gradually decrease of the amount of the pigment liquid in the liquid storage space of the pen tube or the influence of the ambient temperature causes the flow of the pigment liquid to slow down and the smoothness of the liquid output of the cosmetic pens to be reduced. Under these circumstances, the user usually shakes the makeup pen to make the liquid flow out. However, shaking the makeup pen causes the pigment liquid to seep out from the axial air flow path of the pen holder and spray it on the surrounding environment or cosmetic bag.

### SUMMARY OF THE INVENTION

Therefore, in view of the above-mentioned problems, the aspect of the present invention is to provide a pen structure containing liquid ink which has simple structure and automatically and smoothly discharges a liquid stored in the pen structure to evenly distribute the liquid on a brush for a user to use easily during makeup.

Disclosed herein is a pen structure containing liquid ink. It mainly comprises a tube body having a reservoir and an open end; a liquid outflow bushing sleeved at the open end and accommodated in the reservoir of the tube body at one end thereof, wherein the liquid outflow bushing has a liquid delivering space and a screw groove disposed on a wall of the liquid delivering space and connected to an end face of the liquid delivering space at one end thereof; and a brush disposed in the liquid delivering space of the liquid outflow bushing and surrounded by the screw groove at one end thereof.

According to an embodiment of the present invention, an outer wall of the liquid outflow bushing is formed with a tapered part, an annular part, a first connecting part and a second connecting part.

According to an embodiment of the present invention, the annular part contacts the open end of the tube body when the liquid outflow bushing is accommodated in the reservoir of the tube body.

According to an embodiment of the present invention, a diameter of the second connecting part is less than a diameter of the first connecting part.

According to an embodiment of the present invention, the tube body has an inner thread therein for correspondingly screwing to an external thread of a supply tube.

According to an embodiment of the present invention, the brush has an absorbing part for passing through the liquid delivering space of the liquid outflow bushing and a nib.

According to an embodiment of the present invention, the absorbing part of the brush is surrounded by the screw groove.

### BRIEF DESCRIPTION OF THE DRAWINGS

FIG. 1 is an explosion diagram showing a first embodiment for a pen structure containing liquid ink according to the present invention;

FIG. 2 is a partial cross-sectional view showing the first embodiment for the pen structure containing liquid ink according to the present invention;

FIG. 3 is a cross-sectional view showing the first embodiment for the pen structure containing liquid ink according to the present invention;

FIG. 4 is a schematic diagram showing the first embodiment for the pen structure containing liquid ink in use according to the present invention;

FIG. 5 is a first cross-sectional view showing a second embodiment for a pen structure containing liquid ink according to the present invention;

FIG. 6 is a second cross-sectional view showing the second embodiment for the pen structure containing liquid ink according to the present invention.

### DETAILED DESCRIPTION OF THE PREFERRED EMBODIMENT

Hereinafter, an exemplary embodiment of the present invention will be described in detail with reference to the accompanying drawings.

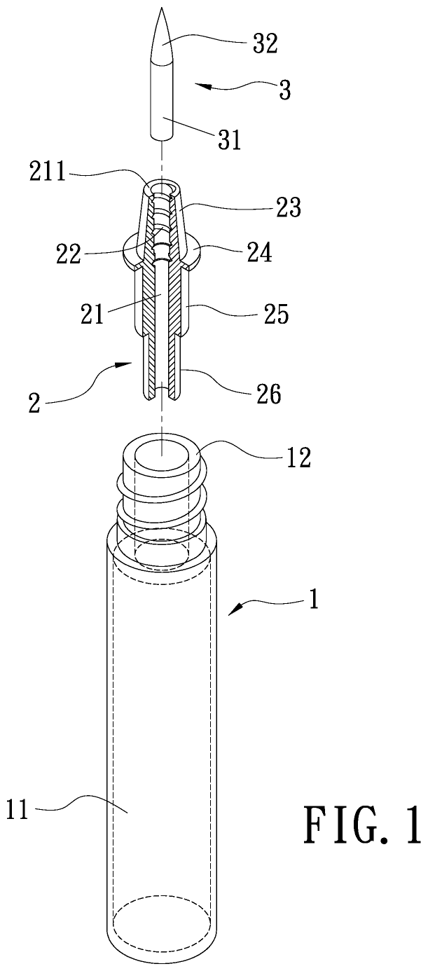

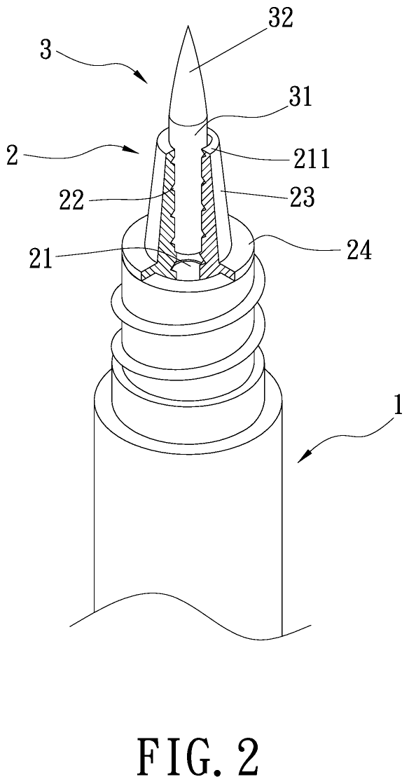

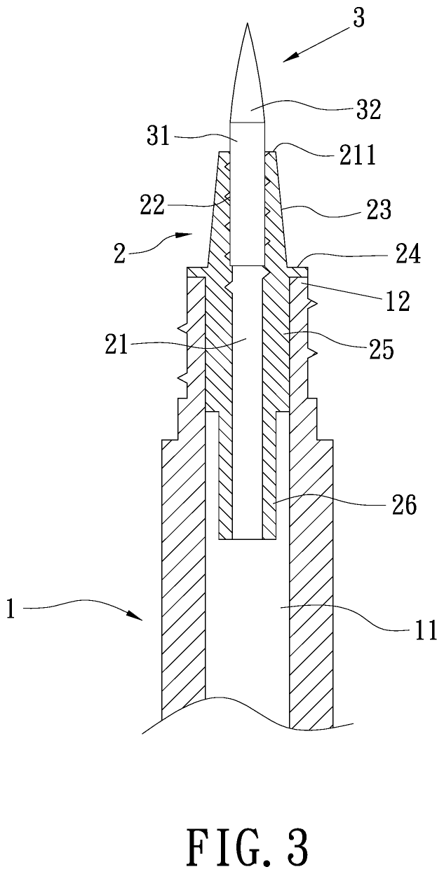

Referring to FIG. 1 to FIG. 3, a first embodiment for a pen structure containing liquid ink according to the present invention is disclosed herein. It mainly comprises a tube body (1), a liquid outflow bushing (2) and a brush (3). The tube body (1) has a reservoir (11) and an open end (12). The liquid outflow bushing (2) is disposed at the open end (12) and accommodated in the reservoir (11) of the tube body (1) at one end thereof. The liquid outflow bushing (2) has a liquid delivering space (21) and a screw groove (22) disposed on a wall of the liquid delivering space (21), and one end of the screw groove (22) is connected to an end face (211) of the liquid delivering space (21). Furthermore, an outer wall of the liquid outflow bushing (2) is formed with a tapered part (23), an annular part (24), a first connecting part (25) and a second connecting part (26). A diameter of the second connecting part (26) is less than a diameter of the first connecting part (25). When the liquid outflow bushing (2) is assembled to the reservoir (11) from the open end (12) of the tube body (1), the annular part (24) contacts the open end (12) of the tube body (1). The brush (3) has an absorbing part (31) and a nib (32). The absorbing part (31) is inserted into the liquid delivering space (21) of the liquid outflow bushing (2) and surrounded by a part of the screw groove (22). Namely, a length of an area surrounded with the screw groove (22) is greater than a length of the absorbing part (31) that is inserted into the liquid delivering space (21).

As shown in FIG. 1 to FIG. 3, in the assembly of the present invention, the absorbing part (31) is loaded into the liquid delivering space (21) of the liquid outflow bushing (2), and the nib (32) is protruded from the liquid outflow bushing (2). In this way, a user can use liquid ink such as an eyeliner through the nib (32). Furthermore, in assembling the liquid outflow bushing (2) to the tube body (1), the liquid outflow bushing (2) is placed into the open end (12) of the tube body (1) until the annular part (24) contacts the open end (12) of the tube body (1). In such a case, the first connecting part (25) and the second connecting part (26) are accommodated in the reservoir (11) of the tube body (1), and the tapered part (23) and the annular part (24) are located outside the tube body (1).

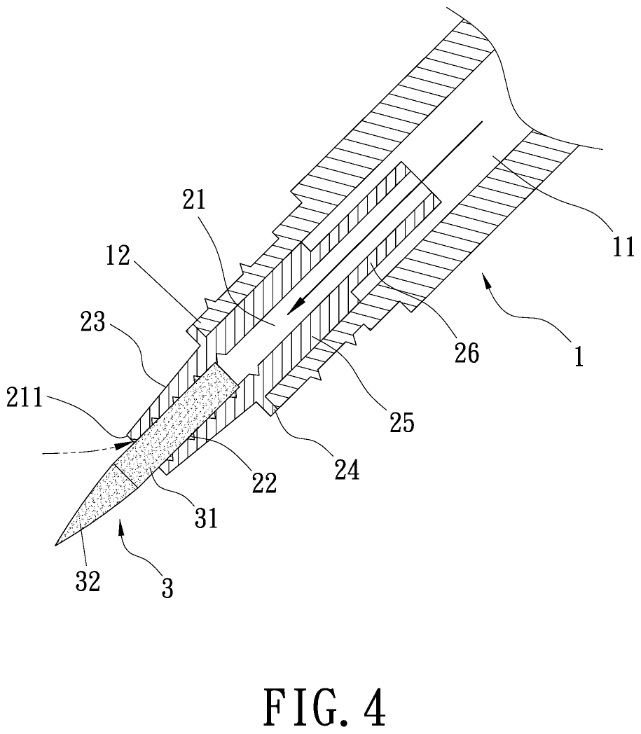

In a practical use, pigment liquid is accommodated in the reservoir (11) of the tube body (1) for further flowing into the liquid delivering space (21) of the liquid outflow bushing (2) as indicated by an arrow in FIG. 4. When the pigment liquid flows into the brush (3) through the liquid delivering space (21), the brush (3) which is usually made of a cotton material absorbs the pigment liquid at the same time. The pigment liquid absorbed by the absorbing part (31) of the brush (3) is discharged from the nib (32). When an amount of the pigment liquid in the reservoir (11) of the tube body (1) is reduced, a negative pressure is formed inside the reservoir (11). Because one end of the screw groove (22) is connected to the end face (211) of the liquid delivering space (21), the screw groove (22) introduces air outside the tube body (1) into the tube body (1) to balance the gas and liquid pressure inside the reservoir (11). Therefore, the pigment liquid outflows from the nib (32) smoothly and continuously without being clogged due to pressure changes.

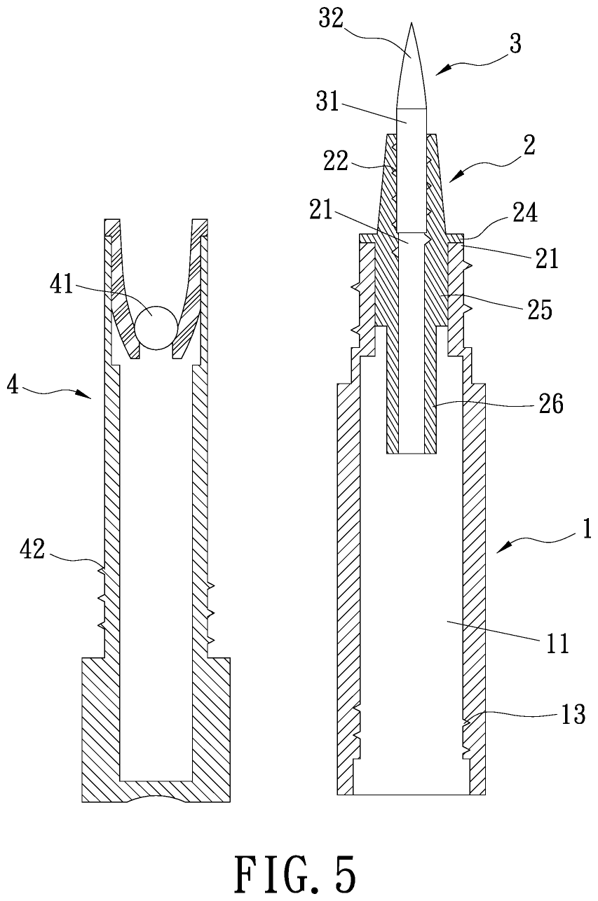

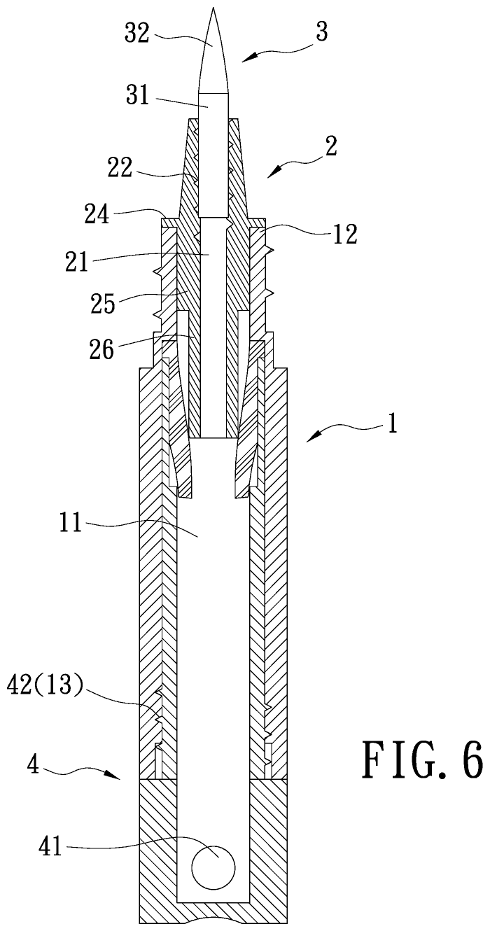

Referring to FIG. 5 and FIG. 6, a second embodiment for a pen structure containing liquid ink according to the present invention is disclosed and can be applied to a pen structure containing an ink cartridge. The tube body (1) is further provided with a supply tube (4) filled with pigment liquid, and an opening of the supply tube (4) is blocked by a steel ball (41). Accordingly, the pigment liquid can be properly stored in the supply tube (4) when it is not yet opened for use, so as to prevent the brush (3) from adsorbing the pigment liquid before the user purchases the pen structure. When the user wants to use the pen structure after purchase, the supply tube (4) is inserted into the tube body (1) and correspondingly screwed into an inner thread (13) on an inner wall of the reservoir (11) of the tube body (1) by an external thread (42) on an outer wall of the supply tube (4), and the steel ball (41) is pushed by the second connecting part (26) of the liquid outflow bushing (2) to fall into the supply tube (4). In this way, the pigment liquid installed in the supply tube (4) flows to the liquid delivering space (21) of the liquid outflow bushing (2), and then flows to the absorbing part (31) of the brush (3) for adsorption.

It can be known from the above embodiments that the present invention can be applied to an eyeliner or an eye shadow pen for cosmetic use, and can also be applied to a pen body containing ink cartridge for general writing.

Compared with the technique available now, the present invention has the following advantages:

1. The present invention comprises the screw groove inside the liquid outflow bushing to introduce air outside the tube body into the tube body to balance the gas and liquid pressure inside the reservoir, so the liquid ink outflows smoothly and stably from the nib.

2. The structure of the present invention comprising the screw groove for balancing the gas and liquid pressure is not complicated and is easy to assemble, which can save the manufacturing and assembly cost.

3. The design of the screw groove can prevent the liquid ink accidentally seeping out from the axial air flow path as in the conventional product even when the user shakes the pen structure.

What is claimed is:

1. A pen structure containing liquid ink, comprising:
a tube body having a reservoir and an open end;
a liquid outflow bushing disposed at the open end and accommodated in the reservoir of the tube body at one end thereof, wherein the liquid outflow bushing has a liquid delivering space and a screw groove disposed on a wall of the liquid delivering space and connected to an end face of the liquid delivering space at one end thereof; and
a brush disposed in the liquid delivering space of the liquid outflow bushing and surrounded by the screw groove at one end thereof.

2. The pen structure containing liquid ink as claimed in claim 1, wherein an outer wall of the liquid outflow bushing is formed with a tapered part, an annular part, a first connecting part and a second connecting part.

3. The pen structure containing liquid ink as claimed in claim 2, wherein the annular part contacts the open end of the tube body when the liquid outflow bushing is accommodated in the reservoir of the tube body.

4. The pen structure containing liquid ink as claimed in claim 2, wherein a diameter of the second connecting part is less than a diameter of the first connecting part.

5. The pen structure containing liquid ink as claimed in claim 1, wherein the tube body has an inner thread therein for correspondingly screwing to an external thread of a supply tube.

6. The pen structure containing liquid ink as claimed in claim 1, wherein the brush has an absorbing part for passing through the liquid delivering space of the liquid outflow bushing and a nib.

7. The pen structure containing liquid ink as claimed in claim 6, wherein the absorbing part of the brush is surrounded by the screw groove.
